(19) United States
(12) Patent Application Publication
(10) Pub. No.: US 2008/0318690 A1
(43) Pub. Date: Dec. 25, 2008

(54) METHODS AND APPARATUS FOR REMOTE PLAY OF A GAMING DEVICE

(76) Inventors: Jay S. WALKER, Ridgefield, CT (US); James A. Jorasch, Westport, CT (US); Thomas M. Sparico, New York, NY (US); Michael W. Patterson, New York, NY (US); Robert C. Tedesco, Fairfield, CT (US); Daniel E. Tedesco, Huntington, CT (US)

Correspondence Address: WALKER DIGITAL MANAGEMENT, LLC, 2 HIGH RIDGE PARK, STAMFORD, CT, 06905, US

(21) Appl. No.: 12/136,978

(22) Filed: Jun. 11, 2008

Related U.S. Application Data
(63) Continuation-in-part of application No. 11/425,010, filed on Jun. 19, 2006.
Application No. 11/425,010 is a continuation of application No. 09/991,056, filed on Nov. 16, 2001, now Pat. No. 7,066,815.
Application No. 09/991,056 is a continuation of application No. 09/401,205, filed on Sep. 22, 1999, now Pat. No. 6,361,437.
Application No. 09/401,205 is a continuation of application No. 08/775,577, filed on Dec. 31, 1996, now Pat. No. 6,001,016.
(60) Provisional application No. 60/943,431, filed on Jun. 12, 2007.

(51) Int. Cl. A63F 9/24; G06F 17/00

(52) U.S. Cl. 463/42; 463/43; 463/25

(57) ABSTRACT

A method and system for remote play of a gaming device, such as a slot machine. In accordance with one embodiment, a first player playing a first device may benefit from an outcome determined via a second gaming device, the second device being played by a second player. The first device and/or the second device may comprise a gaming device operable to facilitate a wagering game. The first player and the second player may each place a wager on the outcome determined via the second device. The wager placed by the first player may be different from the wager placed by the second player. The displays of the two devices may be merged in some embodiments, such that a first portion of the outcome is displayed on a display of the first device and a second portion of the outcome is displayed on a display of the second device.

### CLAIM OF PRIORITY

The present application is a continuation-in-part of U.S. application Ser. No. 11/425,010, filed Jun. 19, 2006 in the name of Walker et al. and entitled REMOTE GAMING DEVICE;

which is a continuation of U.S. application Ser. No. 09/991,056, filed Nov. 16, 2001 in the name of Walker et al., entitled REMOTE GAMING DEVICE, and issued as U.S. Pat. No. 7,066,815 on Jun. 27, 2006;

which Ser. No. 09/991,056 application is a continuation of U.S. application Ser. No. 09/401,205, filed Sep. 22, 1999 in the name of Walker et al., entitled REMOTE GAMING DEVICE, and issued as U.S. Pat. No. 6,361,437 on Mar. 26, 2002;

which Ser. No. 09/401,205 application in turn is a continuation of U.S. application Ser. No. 08/775,577, filed Dec. 31, 1996 in the name of Walker et al., entitled REMOTE GAMING DEVICE, and issued as U.S. Pat. No. 6,001,016 on Dec. 14, 1999.

The present application also claims the benefit of priority of U.S. Provisional Application Ser. No. 60/943,431, filed Jun. 12, 2007 in the name of Jay S. Walker and entitled GAMING PRODUCTS AND METHODS ASSOCIATED THEREWITH.

The entirety of each of the above-referenced applications is incorporated by reference herein for all purposes.

### FIELD

At least some embodiments of the present invention relate to a method and apparatus for operation of a gaming device, such as a slot machine and, more particularly, for remote play of such a gaming device.

### BRIEF DESCRIPTION OF THE DRAWINGS

FIG. 1 is a schematic view of a system according to one embodiment described herein;

FIG. 2 is a schematic view of a slot machine consistent with one embodiment described herein;

FIG. 3 is a schematic view of a slot network server consistent with one embodiment described herein;

FIG. 4 is a schematic view of the player database of a slot network server consistent with one embodiment described herein;

FIG. 5 is a schematic view of a table illustrating one example of a session database consistent with one embodiment described herein;

FIG. 6 is a schematic view of a table illustrating one example of a remote wagering terminal database consistent with one embodiment described herein;

FIG. 7 is a schematic view of a table illustrating one example of a slot machine database consistent with one embodiment described herein;

FIG. 8 is a schematic view of a remote wagering terminal consistent with one embodiment described herein;

FIG. 9 is a schematic view of a cashier terminal consistent with one embodiment;

FIG. 10 is a flow diagram depicting the depositing of funds for use in accordance with one embodiment described herein;

FIGS. 11a and 11b are flow diagrams of one example of a process consistent with one embodiment described herein;

FIG. 12 is a flow diagram depicting a process of receiving a payout in accordance with one embodiment described herein;

FIG. 13 is a flow diagram depicting a process associating a player with a gaming device in accordance with one embodiment described herein; and

FIG. 14 is an example of a tangible medium that may be used to indicate a wager by a player, consistent with at least one embodiment described herein.

### DETAILED DESCRIPTION OF EMBODIMENTS

A method according to one embodiment provides a gaming system which includes a server, a plurality of gaming devices, and a remote wagering terminal. Each of the gaming devices is configured to generate outcome data and communicate (e.g., automatically) the outcome data to the server. Furthermore, the server is configured to determine outcome data from at least one of the gaming devices for receipt by the remote wagering terminal.

In accordance with another embodiment of the present invention, a method provides for receiving a play preference, generating by a gaming device outcome data, communicating the outcome data from the gaming device to a server, selecting outcome data based upon the play preference, and communicating the selected outcome data to a remote wagering terminal. In another embodiment, the method includes simulating an outcome of the gaming device based upon the outcome data.

A method according to another embodiment provides for receiving (e.g., automatically) outcome data from a gaming device, wherein the gaming device is of a type wherein a paid play initiates a random event that results in the outcome data, selecting outcome data, and communicating the outcome data to a remote wagering terminal.

According to another embodiment, the method includes the steps of receiving outcome data, and generating simulated play based upon the outcome data.

The present invention is directed generally to a method and system for remote play of a gaming device, such as a slot machine. A player enters play preferences at a remote wagering terminal. The remote wagering terminal transmits the play preferences to a slot network server that stores the play preferences. Based upon the play preferences, the slot network server identifies the outcome data from one or more slot machines and transmits this outcome data from those slot machines to the remote wagering terminal. One embodiment utilizes live outcome data while another embodiment utilizes stored, historical outcome data from previous plays of a slot machine. In an alternate embodiment, the slot network server generates simulated outcome data for display by the remote wagering terminal. The slot network server keeps track of the player's wins and losses based upon the outcome data.

In some embodiments, the remote wagering terminal may be a gaming device operable to facilitate a wagering game (e.g., a slot machine) in addition to being operable to display outcomes obtained via another gaming device.

In some embodiments, the remote wagering terminal may be a handheld, wireless and/or portable device operable to display outcomes of a wagering game and/or to receive inputs (e.g., wager amounts) for a wagering game. In various embodiments, a gaming device may comprise, for example, a personal computer (e.g., which communicates with an online casino Web site), a telephone (e.g., to communicate with an automated sports book that provides gaming services), or a portable handheld gaming device (e.g., a device similar to a PDA). The gaming device may comprise any or all of the gaming devices of the aforementioned systems. In some embodiments, a user device such as a PDA or cell phone may be used in place of, or in addition to, some or all of the gaming device components. For example, in some embodiments, a gaming device may comprise a wireless handheld device similar to the WifiCasino GS offered by Diamond I Technologies of Baton Rouge, Louisiana. Further, a gaming device may comprise a personal computer or other device, which may be operable to communicate with an online casino and facilitate game play at the online casino. In one or more embodiments, the gaming device may comprise a computing device operable to execute software that simulates play of a reeled slot machine game, video poker game, video blackjack game, video keno game, video roulette game, or lottery game.

Certain embodiments will now be described in greater detail with reference to the drawings. Although the embodiments discussed herein are directed to slot machines, it is to be understood that the present invention is equally applicable to other gaming devices, such as video poker machines, video blackjack machines, video roulette machines, video keno machines, video bingo machines, and the like.

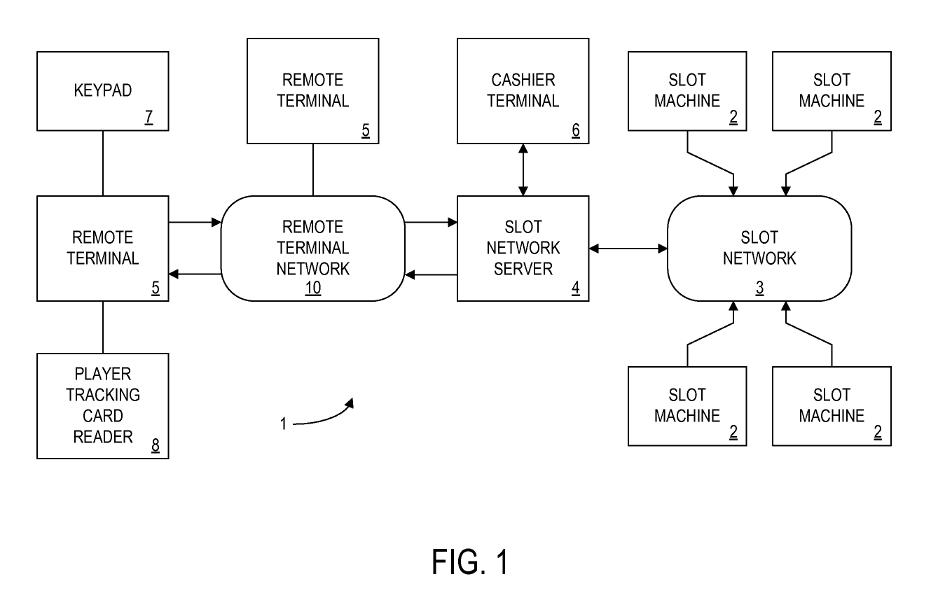

With reference to FIG. 1, a system 1 is shown. In general, the system 1 includes multiple slot machines 2 in communication with a slot network server 4 via a conventional local area network (slot network) 3. The slot network 3 is controlled by the server 4. It is to be understood that communication between each sot machine 2 and the server 4 may also occur across a wireless network, internet or other appropriate connection. The remote wagering terminals 5 also communicate with the slot network server 4 being coupled to the slot network server 4 via a remote wagering terminal network 10. The remote wagering terminal network 10 may be a conventional local area network that is controlled by the server 4 or may be a wired network, wireless or other appropriate network, as described with respect to slot network 3. Each remote wagering terminal 5 includes a keypad 7 (or other appropriate input mechanism, such as a touch screen) and a player tracking card reader 8. A cashier terminal 6 is in communication with the server 4.

As will be discussed in greater detail below, each slot machine 2 communicates outcome data to the slot network server 4. As used herein, outcome data includes all information capable of being passed from a slot machine 2 to the slot network server 4. Such outcome data may include whether a player playing the particular slot machine 2 has won or lost, the amount of the payout (if any), the amount lost (if any), and, in one embodiment, the outcome of a play of the slot machine 2, namely the position of the reels on the slot machine 2.

In an embodiment in which the gaming device is a video poker machine, a video blackjack machine, or another gaming device for which play is based upon playing cards, the outcome is the card values. Similarly, in an embodiment in which the gaming device is a video roulette machine, the outcome is the final number and color.

Outcome data is further defined as live or historical. Live outcome data is outcome data not previously received by the slot network server 4. Thus, live outcome data typically represents the most recent play of a given gaming device and may be received simultaneously or substantially simultaneously with the outcome being generated. Historical outcome data, on the other hand, is outcome data previously received from a gaming device and stored. Thus, historical outcome data typically represents plays, other than the most recent, of a gaming device.

Because each slot machine 2 has a unique machine identification (ID) number, the slot network server 4 is able to distinguish the outcome data as being sent from a particular slot machine 2 and to store the outcome data with reference to that particular machine 2.

Communication with respect to embodiments described herein between the remote wagering terminal 5 and slot network server 4 is initiated when a player inserts a player tracking card 9 into the player tracking card reader 8. Typically, a casino issues a player tracking card 9 containing player identifying information. Such identifying information can be any information that uniquely identifies a player to the system 1 and, in the present embodiment, includes the player identification (ID) number. The identifying information is preferably stored on a magnetic strip on the player tracking card 9.

The player tracking card reader 8 reads the player identifying information from the player tracking card 9 and transmits the information to the slot network server 4. Because the player identifying information uniquely identifies a given player, the slot network server 4 is able to access information associated with that player, such as a credit balance.

As discussed below, once a remote player has inserted the player tracking card 9 into the card reader 8, the remote player enters play preferences through a touch screen or, in the illustrated embodiment, an alphanumeric keypad 7 to initiate remote slot machine play. Play preferences include any information that defines which gaming device or devices are to be played and how they are to be played. Thus, play preferences may include one or more of the number of devices to be accessed, bet per play, type of device, type of game, location of device, denomination of device, speed of play, machine ID number (if available), and the like. The slot network server 4 is able to identify the remote wagering terminal 5 source of the play preferences because each remote wagering terminal 5 has associated therewith a remote wagering terminal identification (ID) number that uniquely identifies the remote wagering terminal 5.

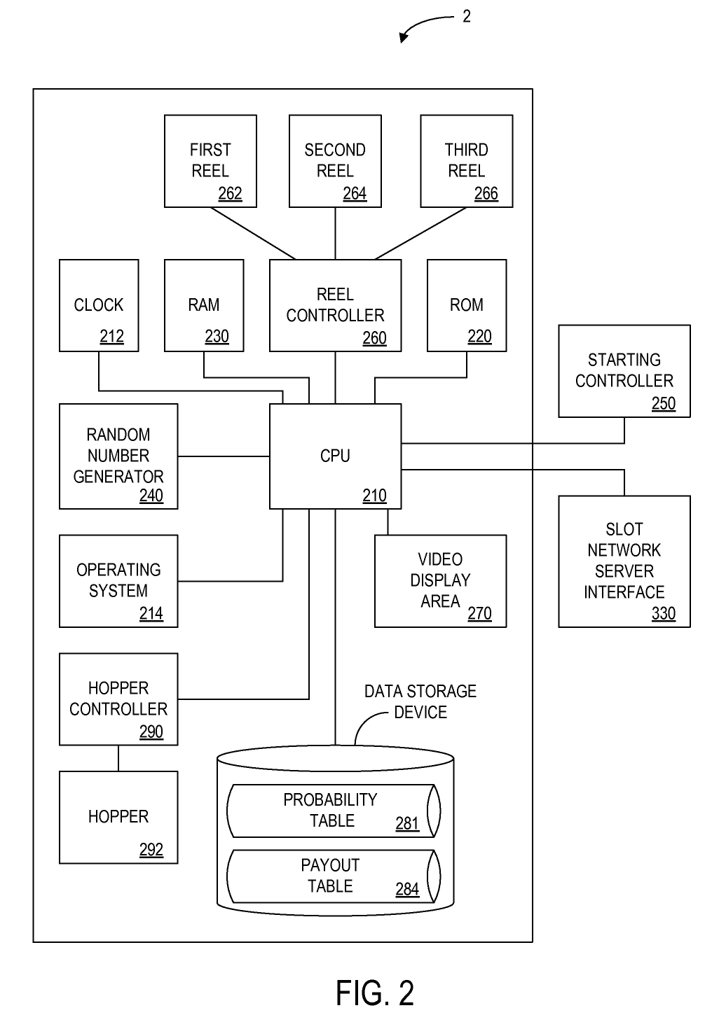

With reference to FIG. 2, the slot machine 2 will now be described in greater detail. Each slot machine 2 includes a Central Processing Unit (CPU) 210, a clock 212, and an operating system 214 stored in memory. The CPU 210 executes instructions of a program stored in Read Only Memory (ROM) 220 for playing the slot machine 2. The Random Access Memory (RAM) 230 temporarily stores information passed to it by the CPU 210. A Random Number Generator (RNG) 240 is also in communication with the CPU 210.

With respect to a play of the slot machine 2, slot machine 2 operates in a conventional manner. The player starts the machine by inserting a cashless gaming receipt, one or more coins, using electronic credit, or any other appropriate payment means and activating a starting controller 250. Under control of a program stored, for example, in a storage device 280 or the ROM 220, the CPU 210 initiates the RNG 240 to generate a random number; the CPU 210 looks up the generated random number in a stored probability table 282 and finds the corresponding outcome. Based on the identified outcome, the CPU 210 locates the appropriate payout in a stored payout table 248. The CPU 210 also directs a reel controller 260 to spin reels 262, 264, 266 and to stop them at a point when they display a combination of symbols corresponding to the selected payout. When the player wins, the machine stores the credits in RAM 235 and displays them in video display area 270. It should be noted that in some embodiments, an RNG may be located in a server in communication with the slot machine 2 (e.g., in slot server 4), which may generate a random number or pseudo random number and transmit it to slot machine 2 for display.

A hopper controller 290 is connected to a hopper 292 for dispensing coins. When the player requests to cash out by pushing a button on the slot machine 2, the CPU 210 checks the RAM 235 to see if the player has any credit and, if so, signals the hopper controller 290 to release an appropriate number of coins into a payout tray (not shown). If appropriate, the CPU 210 may cause a cashless gaming receipt mechanism to print a cashless gaming receipt indicative of the player's final credit meter balance in addition to, or in lieu of, dispensing coins into the payout tray. In another embodiment, a cashout request may result in the credits due to the player (or an indication thereof) being stored in a memory of a player tracking card or in a casino account associated with the player.

In alternative embodiments, the slot machine 2 does not include the reel controller 260 and reels 262, 264 266. Instead, a video display area 270 graphically displays representations of objects contained in the selected game, such as graphical reels or playing cards. These representations are preferably animated to display playing of the selected game.

Also connected to the CPU 210 is a slot network server interface 330. The network server interface 330 provides a communication path from the slot machine 2 to the slot network 3 and, therefore, to the slot network server 4. Thus, as discussed in greater detail below, outcome data can be exchanged between the slot machine 2 and the slot network server 4.

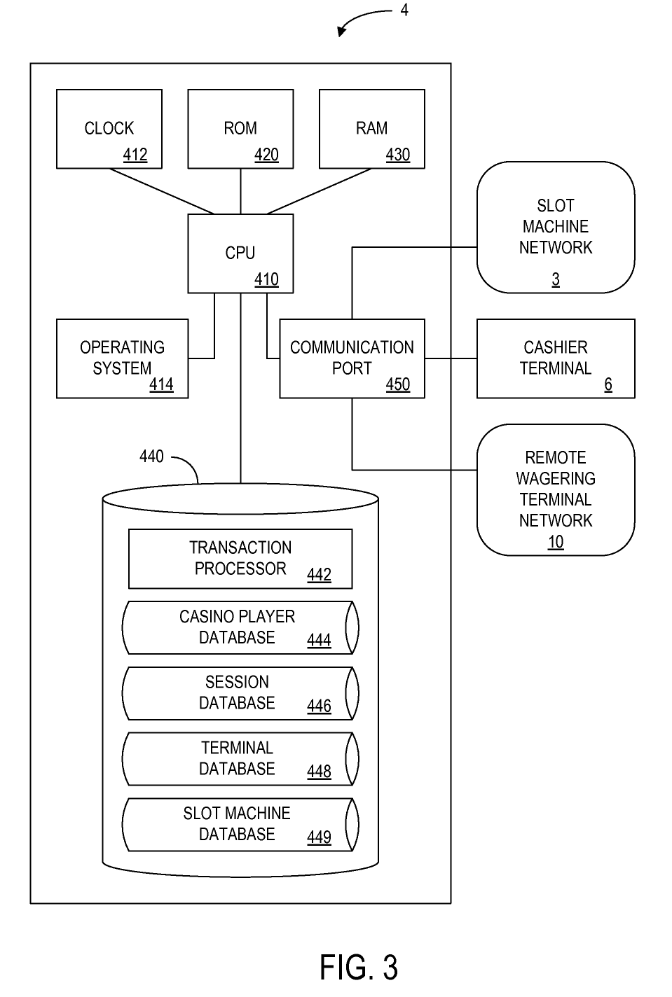

With reference to FIG. 3, the slot network server 4 will now be described in greater detail. Like the slot machine 2 of FIG. 2, the slot network server 4 has a Central Processing Unit (CPU) 410. The CPU 410, which has a clock 412 and operating system 414 associated therewith, executes instructions of a program stored in Read Only Memory (ROM) 420. During execution of the program instructions, the CPU 410 temporarily stores information in the Random Access Memory (RAM) 430.

In order to communicate with the remote wagering terminal 5, the slot network sever 4 also includes a communication port 450. The communication port 450 is coupled to the CPU 410, as well as to the slot machine network 3, remote wagering terminal network 10, and cashier terminal 6. Thus, the CPU 410 can control the communication port 450 to receive and transmit information from each slot machine 2, each remote wagering terminal 5, and the cashier terminal 6.

Additionally, the CPU 410 is coupled to a data storage device 440, having a transaction processor 442, a casino player database 444, a session database 446, a terminal database 448, and a slot machine database 449. In general, the transaction processor 442 manages the contents of the data storage device 440.

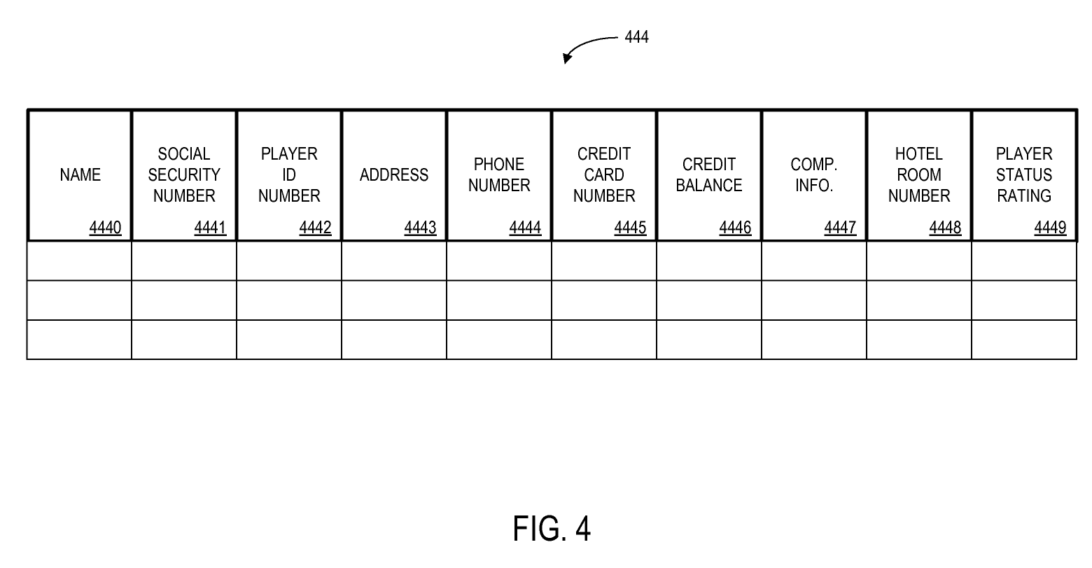

In general, the casino player database 444 of the present embodiment, as shown in FIG. 4, includes multiple records having multiple fields of information related to player identification. Specifically, the player database 444 comprises multiple records, each record being associated with a particular player, as identified by a player identification (ID) number. The fields within each record include: name 4440, social security number 4441, player ID number 4442, player address 4443, telephone number 4444, credit card number 4445, credit balance 4446, complimentary information 4447, such as complimentary points awarded, hotel room number 4448, and player status rating 4449. Thus, having information related to one field, such as player ID 4442, allows the slot network server 4 to retrieve all information stored in the other fields of that player's record.

It is to be understood that for purposes of the present embodiment, only the player ID number field 4442, and the credit balance field 4446 are necessary. The remaining fields are merely representative of additional information that may be stored and used for other purposes. For example, credit card number 4445 and hotel room number 4448 are used for billing purposes and social security number 4441 is used to generate tax forms when a player wins a jackpot over a given amount.

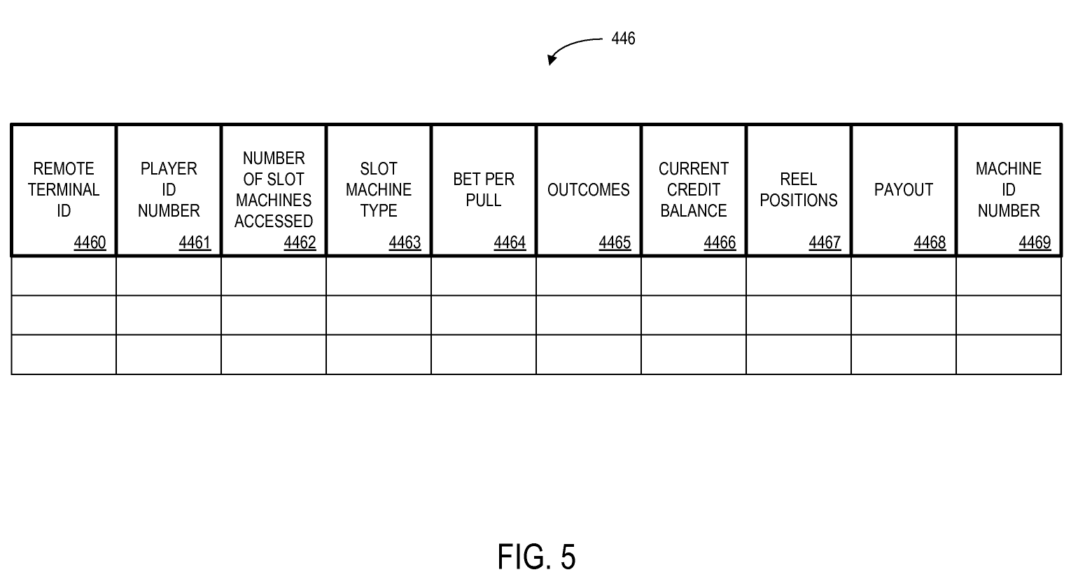

The session database 446, as shown in FIG. 5, comprises multiple records, each record pertaining to the remote play session of a particular player, as identified by a remote wagering terminal ID number. Consequently, one field in each record is the remote wagering terminal ID field 4460. Other fields include: player ID 4461, number of slot machines to be accessed 4462, slot machine type 4463, bet per pull 4464, machine denomination 4465, credit balance 4466, reel position 4467, payout 4468, and machine ID number 4469. Because both the player database 444 and the session database 446 include a player ID field (4442 and 4461, respectively), the system 1 can correlate any information stored in the player database 444, corresponding to a particular player, with any information stored in the session database 446, corresponding to that same player.

As described below, a player may choose multiple slot machines 2 for remote play. The number of machines 2 chosen is stored in the “number of slot machines to be accessed” field 4462. For each slot machine 2 accessed, the session database includes information fields such as a machine ID number field and a machine type field for each slot machine 2 being accessed.

For simplification of the following description, reference is made to the fields in the session database 446 as if only one slot machine 2 is being accessed. It is to be understood that a step which is described with reference to a particular field applies to that field for any number of slot machines 2 being accessed.

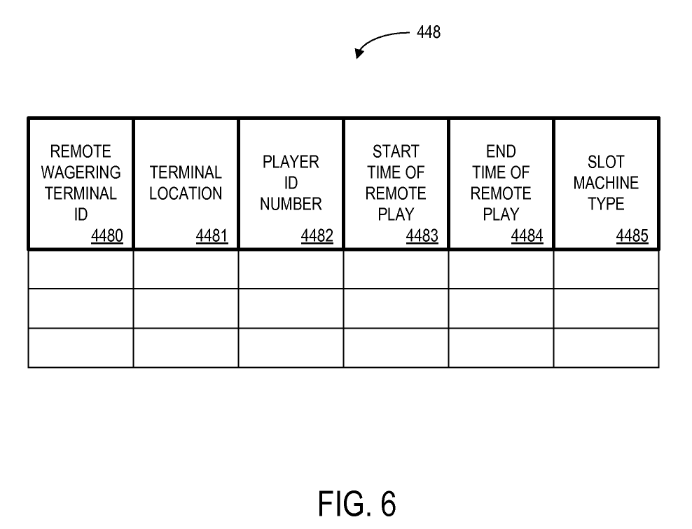

The remote wagering terminal database 448, as shown in FIG. 6, includes multiple records, each record pertaining to a different remote wagering terminal 5 as identified by a remote wagering terminal ID number as stored in the remote wagering terminal ID field 4480. The additional fields in each record include: terminal location 4481, player ID 4482, start time of remote play 4483, end time of remote play 4484, and slot machine type 4485. It is to be understood that the system 1 may, for example, use the information stored in the remote wagering terminal database 448 to determine which terminals 5 are used most often, when each terminal is in use, and the location of the remote wagering terminals 5 being used. Because the remote wagering terminal database 448, like the session database 446 and the player database 444, contains a player ID field 4482, the system 1 can correlate information contained within the above three databases 444, 446, 448 for a particular player, as identified by the player ID.

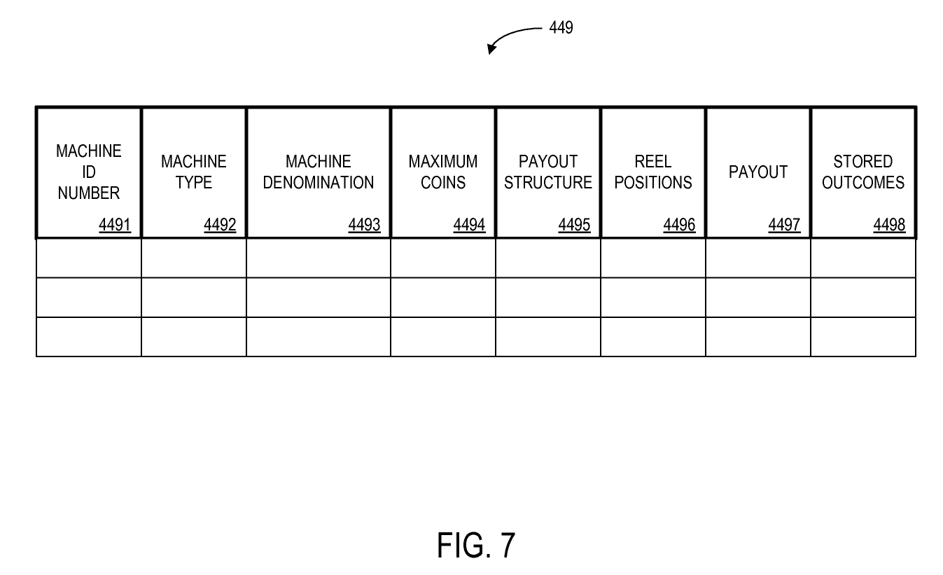

The slot machine database 449 relates to information concerning particular slot machines 2. As illustrated in FIG. 7, each slot machine 2 has an associated record in the database identified by a machine ID number, as stored in the machine ID number field 4491. The other fields in the slot machine database 449 include: machine type 4492, machine denomination 4493, maximum coins allowed 4494, pay out structure 4495, outcome data, and in this embodiment, reel position 4496 and payout 4497, and historical outcome data 4498. Because the slot network server 4 may search any field in a slot machine database 449, the server 4 is able to identify a slot machine 2 not only by its machine ID number 4491, but also by the type 4492 and denomination 4493 of a slot machine 2.

The payout structure 4495 of the slot machine database 449 relates payout information, to machine outcome. Specifically, the payout structure 4495 correlates a given payout, such as ten coins, to a reel outcome that results in that payout, such as “cherry-cherry-bar.”

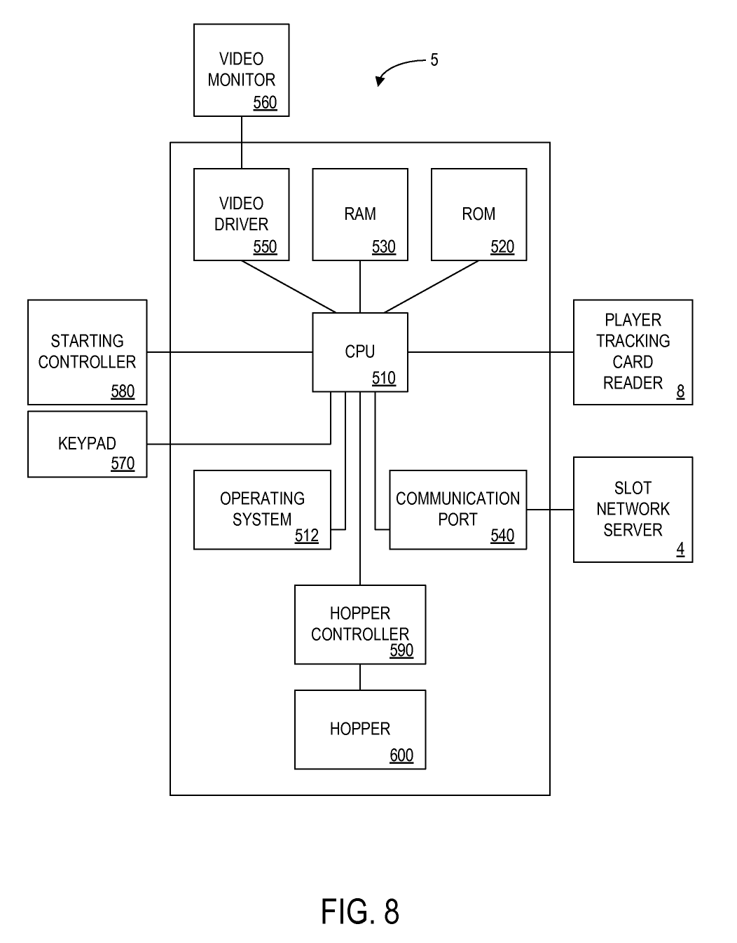

The remote wagering terminal 5 will now be described in greater detail with reference to FIG. 8. The remote wagering terminal 5 includes an operating system 512 and a Central Processing Unit (CPU) 510 that executes instructions from a program stored in Read Only Memory (ROM) 520. During such execution, the CPU 510 temporarily stores and retrieves information from the Random Access Memory (RAM) 530.

The CPU 510 can access information from several sources. For example, the CPU 510 accesses the slot network server 4 via a communication port 540. Additionally, as described in greater detail below, the remote wagering terminal 5 may read player identifying information from a player tracking card 9, which has been inserted into the player tracking card reader 8, and then communicate that information, via the communication port 540, to the slot network server 4. Similarly, the slot network server 4 may transmit information to the CPU 510.

Additionally, the CPU 510 is coupled to a video driver 550. The video driver 550, in turn, is coupled to a video monitor 560. The video driver 550, as directed by the CPU 510, displays outcome data of one or more slot machines 2 that has been received from a slot network server 4.

Also connected to the CPU 510 is a keypad 570. The keypad 570 may be used by a player to input any alphanumeric information, such as play preferences, as required. The information entered by the player via the keypad 570 is available to the remote wagering terminal 5, as well as the slot network server 4 and the individual slot machines 2.

Like each slot machine 2, in some embodiments each remote wagering terminal 5 has a starting controller 580, a hopper controller 590, and a hopper 600. In such embodiments, as with each slot machine 2, these components are coupled to the CPU 510. The starting controller 580 is used to initiate play at the remote wagering terminal 5. The hopper controller 590 controls the hopper 600 as in the slot machine 2, to make a payout. In an alternate embodiment, the remote wagering terminal 5 does not make a payout, but rather directs the slot network server 4 to increment the credit balance 4446 by the amount of the payout.

It should be understood from the above description that a remote wagering terminal 5 may comprise a slot machine or other gaming device that is operable to facilitate one or more embodiments of the present invention. For example, a remote wagering terminal may, in some embodiments, be operable to facilitate conventional slot machine or gaming machine play while, in some modes, be further operable to facilitate the output of outcomes obtained on another slot machine, such as a slot machine 2.

It should further be understood from the description herein that the remote wagering terminal may comprise any device operable to facilitate the function of allowing remote play of a gaming device such as a slot machine. For example, the remote wagering terminal may itself comprise a slot machine or another gaming device. In another example, remote wagering terminal 5 may comprise a handheld terminal (whether wired or wireless connected to another device). Such a handheld terminal may comprise, for example, a device dedicated to allowing remote play of a gaming device. Alternately, such a handheld terminal may comprise a device operable to facilitate functions in addition to those of remote gaming (e.g., the handheld terminal may comprise a cellular telephone, a Personal Digital Assistant (PDA), an MP3 player (e.g., Ipod™) and/or a pager). In yet another example, the remote wagering terminal 5 may comprise a television (e.g., a television located in a hotel room of a hotel associated with a gaming establishment) or a personal computer (PC), and so on.

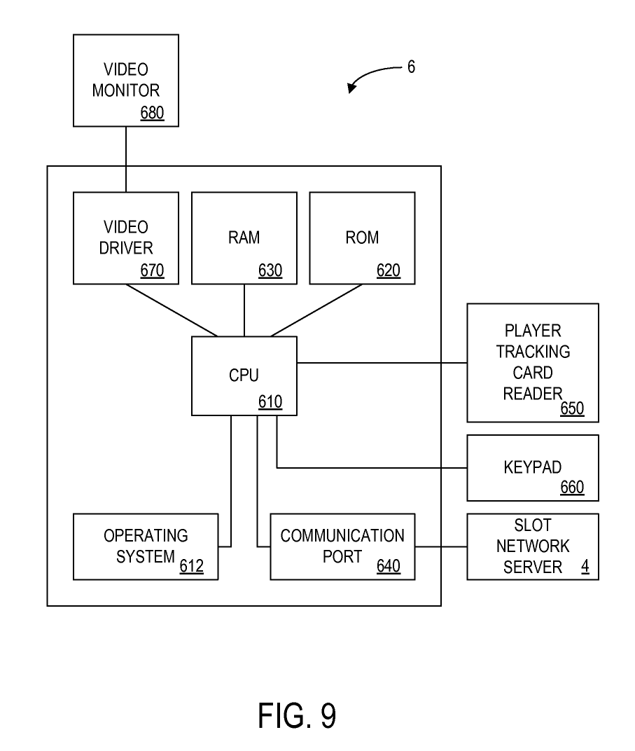

The cashier terminal 6 will now be described in greater detail with reference to FIG. 9. The cashier terminal 6 includes a Central Processing Unit (CPU) 610, which executes instructions of a program stored in Read Only Memory (ROM) 620. The CPU 610 has associated therewith an operating system 612 stored in memory. During execution of the instructions stored in ROM 620, the CPU 610 temporarily stores information in a Random Access Memory (RAM) 630.

A communication port 640 is interposed between the CPU 610 and the slot network server 4. Therefore, the CPU 610 can transmit information to the slot network server 4, and the slot network server 4 can transmit information to the CPU 610.

As with the remote wagering terminal 5, the cashier terminal 6 includes a player tracking card reader 650 connected to the CPU 610. The player tracking card reader 650 reads the player identifying information from a player tracking card 9 that has been inserted therein. The CPU 610, by controlling a video driver 670, may display the player identifying information on a video monitor 680.

Additionally, the cashier terminal 6 includes a keypad 660 connected to the CPU 610. Casino personnel, as described below, use the keypad 660 to input data. The cashier terminal 6 transmits this data via the communication port 640 to the slot network server 4 for use by the slot network server 4 in updating the databases contained therein.

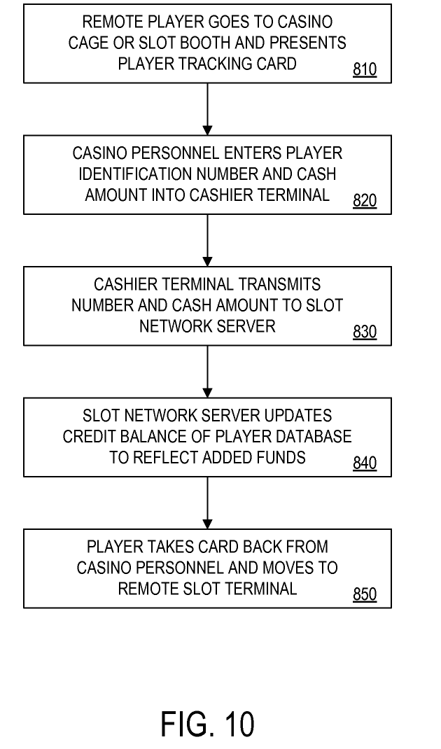

Having thus described the components of the present embodiment, the general operation of the system 1 will now be described with reference to FIG. 10, and continuing reference to FIGS. 1-9.

As an initial step in the operation of the present embodiment, the remote player adds funds to the credit balance 4446. Shown as step 810, the player adds funds by producing the player tracking card 9 and depositing a certain amount of funds at the cashier terminal 6. Casino personnel enter the player's tracking card 9 into the card reader 650 to read the player's ID number for display on the video monitor 680. In step 820, the personnel enter the player's ID number and the amount of funds deposited using the keypad 660. The cashier terminal 6 transmits the player ID number and the amount of funds deposited to the slot network server 4 in step 830.

The server 4 then accesses the record in the player database 444 containing the received player ID number. The server 4, in step 840, proceeds to increment the credit balance 4446 in the particular player's record by the amount of funds deposited. In short, the remote player has converted cash into a credit balance for use at a remote wagering terminal 5. When the transaction is completed, as shown in step 850, the casino personnel return the player tracking card 9, and the player is ready to initiate remote play.

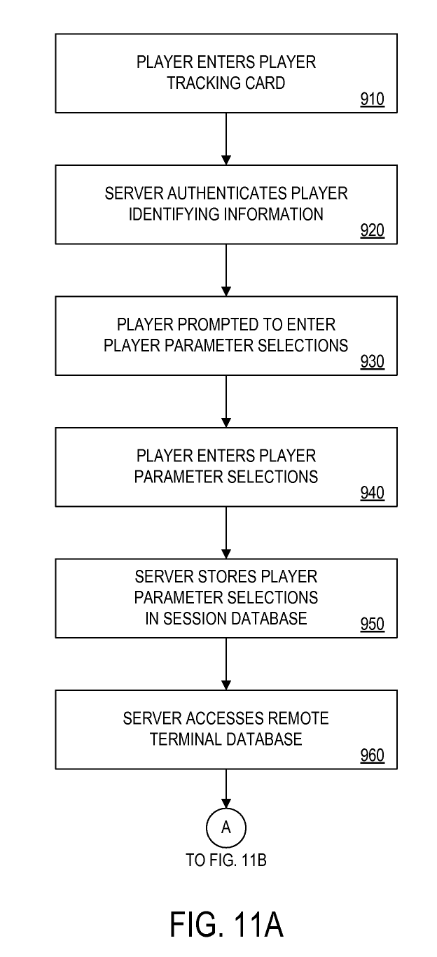

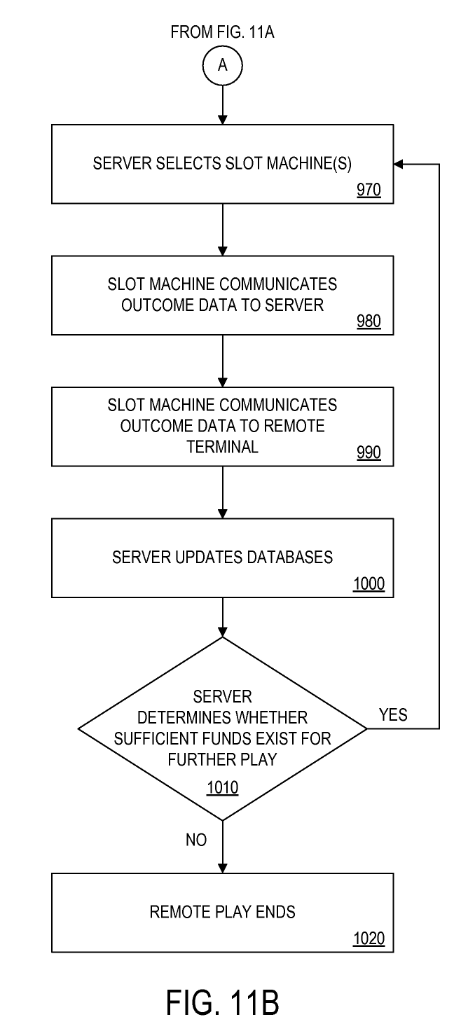

As will now be described with reference to FIG. 11, once the player has added funds to the credit balance 4446, the player proceeds to a remote wagering terminal 5 to initiate remote play. In step 910, the remote player enters the player tracking card 9 into a player tracking card reader 8 associated with a particular remote wagering terminal 5. The player tracking card reader 8 reads the player identifying information on the player tracking card 9 and communicates that information to the CPU 510. The CPU 510, in turn, transmits the player identifying information, via the communication port 540, to the slot network server 4. Upon receiving the identifying information, the slot network server 4 authenticates the player ID.

Authenticating the player ID, as shown as step 920, involves the slot network server 4 receiving the player ID via the communication port 450 and searching the player database 444 for the record having the received player ID number in the player ID number field 4442. If no record exists in the player database 444 having the particular player ID number, then the remote player is rejected, and remote play is not allowed. On the other hand, if the transaction processor 442 identifies a record in the player database 444 containing the player ID number, and the player name, then the remote player is accepted for remote play. In an alternate embodiment, additional identifying information may be checked, such as social security number, telephone number, address, and the like.

Once the slot network server 4 authenticates the player name and the player ID, the remote player proceeds to enter play preferences. Preferably, as shown as step 930, the remote wagering terminal 5 generates a prompting message on the video monitor 560, requesting that the remote player enter the play preferences. Specifically, the slot network server 4 transmits a signal to the remote wagering terminal 5, initiating the prompting of the message. In response to the prompt on the video monitor 560, the remote player proceeds to enter play preferences via the touch screen of the video monitor 560. Alternatively, the player uses the keypad 570. Entering the play preferences is shown as step 940. The remote wagering terminal 5 accepts the entered play preferences and transmits them to the slot network server 4.

Upon receiving the play preferences, the slot network server 4 stores them in the session database 446, as shown as step 950. The particular record in the session database 446 in which the play preferences are stored is defined by the remote wagering terminal ID in field 4460 and the remote player's ID in the player ID number field 4461. In the present embodiment, the play preferences include: the number of slot machines to be accessed 4462, the slot machine type 4463, the slot machine denomination 4465, and the slot machine ID number 4469 of a particular slot machine 2.

A player is able to enter the machine ID number 4469 of a particular slot machine 2 because each slot machine 2 prominently displays an ID tag containing the ID number for that slot machine 2. It is also anticipated that the casino will provide a map of all slot machines 2, each machine being identified by its machine ID number. In practice, a player will identify a machine 2 that is in the player's opinion, “due to hit,” enter that machine's ID number as a play preference, and remotely wager on the play of that slot machine 2.

The play preferences also include play options, such as the bet per pull 4464. Storing the play preferences in the session database 446 is shown as step 950. In addition to the play preferences, the remote wagering terminal 5 transmits its terminal ID number to the slot network server 4 for inclusion in field 4460 of the player's record in the session database 446.

In one embodiment, a player preference may comprise an indication of a number of paylines to be wagered on and/or an indication of particular paylines of a plurality of available paylines to be wagered on. In some embodiments, a player betting via a remote wagering terminal 5 may be limited, for a given round of a game being played on a slot machine, to only betting on paylines not being wagered on (in the case of live outcome data) or not having been wagered on (in the case of historical outcome data) by a player operating the slot machine 2 from which the outcome data is being used. For example, if three paylines “A”, “B” and “C” are available for a game at a slot machine 2 and, for a given round of the game, a player operating slot machine 2 bets on payline “A”, the player betting on the same round of the game via a remote wagering terminal 5 may be limited to betting on either payline “B” and/or payline “C” but not be able to bet on payline “A.”

With regard to steps 930-950, the player preferably enters the “number of machines to be accessed” 4462 first. The system 1 repeats steps 930-950 as many times as the number of machines to be accessed 4462. Thus, a set of play preferences for each slot machine 2 to be accessed is stored in the session database 446. Furthermore it is to be understood that a player need not enter a play preference for each corresponding field in the session database 446.

For example, a player may decide to remotely wager on two slot machines—a particular slot machine 2 and a slot machine 2 of a particular type and denomination. Specifically, the player first enters “two (2)” as the number of machines to be accessed 4462. The player proceeds to enter the first set of play preferences associated with the first machine 2 to be played, namely the machine ID number 4469, as read from the ID tag or slot machine map and the bet per pull 4464.

The player then enters the second set of play preferences associated with the second slot machine 2 to be played. Specifically, the player enters the slot machine type 4463 to be wagered on, such as a “pinball” slot machine, the slot machines denomination 4465, such as a “dollar” slot machine, and the bet per handle pull 4464, such as three coins or dollars.

It should be noted that, in some embodiments, the player who is wagering on a slot machine via a remote wagering terminal 5 may be betting a different amount than a player who is playing, or who has played, the slot machine directly (i.e., not via a remote wagering terminal). In some embodiments, the available bet per handle pull or available max bet per handle pull available to a player placing a bet on a handle pull of a slot machine via a remote wagering terminal 5 may be different from the bet per handle pull or maximum bet per handle pull available to a player playing the slot machine directly.

Further, in some embodiments, the player receiving outcomes of a slot machine via a remote wagering terminal 5 and a player receiving the outcomes of the slot machine by playing the slot machine directly may receive the same outcomes, though placing differing wagers. Such outcomes may be received by such two players in real time (e.g., the outcomes received via the remote wagering terminal 5 are “live” outcomes), substantially real time (e.g., with a short delay), or asynchronously (e.g., the outcomes obtained by the player playing the slot machine directly are stored and then later revealed to the player obtaining the outcomes via a remote wagering terminal 5). The respective payout each of the players receives for a given outcome may differ, based on the respective wager placed by each player on the handle pull that resulted in the outcome.

Having received the play preferences, the slot network server 4 as shown in step 960, accesses the record in the remote wagering terminal database 448 identified by the remote wagering terminal ID 4480. The server 4 proceeds to enter the player ID number into the appropriate field 4482 of the record.

Having created the record in the remote wagering terminal database 448, the slot network server 4 searches the slot machine database 449 for a slot machine 2 defined by a set of play preferences previously stored in the session database 446. Thus, in step 970, the slot network server 4 selects any number of slot machines 2 as identified by the number of machines to be accessed field 4462. Preferably, the server 4 selects slot machines 2 that are currently being played by players physically present at the slot machines 2 so as to use live outcome data.

As shown as step 980, the slot network server 4 receives live outcome data from the selected slot machines 2. Where the live outcome data includes the outcome, i.e. reel positions, the reel positions may be received by the server 4 one at a time or all three at once. Furthermore, so that the server 4 can identify which of the received outcome data corresponds to which slot machine 2, the slot machine 2 transmits the outcome data along with its machine ID number. In alternate embodiments, other machine identifying information may be transmitted with the outcome data.

In an alternate embodiment, the outcome data transferred in step 980 of FIG. 11 need only include the payout 4497, if any. In such an alternative embodiment, the slot machine 2 communicates only the payout information to the slot network server 4. The slot network server 4, as an alternative to step 990 of FIG. 11, simulates an outcome representative of that payout information.

The server 4 simulates an outcome by accessing the slot machine database 449 and, based upon the machine ID number transmitted with the payout 4497, the record for that slot machine 2. A payout structure for that particular slot machine 2 is maintained within the record in field 4495. The payout structure, like the payout table 284 in the slot machine 2, correlates the payout received from slot machine 2 to a possible reel result.

For example, when the reels 262, 264, 266 of the slot machine 2 reveal “cherry-cherry-bar,” the slot machine 2 may have determined that, according to the payout table 284, the player should receive a payout of ten coins. The slot machine 2 then communicates to the slot server 4 a payout of ten coins. The server 4, by a accessing the payout structure, correlates the payout of ten coins back into the reel positions of “cherry-cherry-bar.” Because several reel positions may correspond to the same payout, the slot network server 4 may determine that the reel positions are different than the outcome “cherry-cherry-bar” that occurred on the slot machine 2. Thus, the server 4 generates a simulated outcome of the slot machine 2 for transmission to the remote wagering terminal 5.

In an alternate embodiment, no live outcome data is received from a slot machine 2 in step 480. Instead, the slot network server 4 selects historical outcome data previously stored in field 4498 of the slot machine database 449. As when live outcome data is used, the server 4 selects the historical outcome data 4498 based upon the play preferences.

As will be apparent to one skilled in the art, use of historical outcome data 4498 is particularly advantageous to owners of slot machines 2. Each piece of outcome data received by the server 4 has inherent value. This value stems, at least in part, from the resources required to generate the outcome data, capital investment in each slot machine 2, electricity to operate the slot machine 2, and wear on the slot machine 2 from each play. Thus, by storing the outcome data in the historical outcome data field 4498, the system 1 is able to reuse outcome data and, in a sense, recycle it.

In alternate embodiments, the historical outcome data 4498 includes the historical outcome of at least one play of a gaming device, the historical payout of at least one play of a gaming device, or both the historical outcome and historical payout. Where the historical outcome data 4498 includes both historical outcome and historical payout information, the slot network server 4 merely retrieves the historical outcome data 4498 and the system 1 proceeds from step 990, as described above, based upon this information. Where the historical outcome data 4498 is just historical outcome, the server 4 determines the historical payout information by accessing the payout structure 4495. The server 4 then proceeds from step 990.

Where the historical outcome data 4498 includes only historical payout information, the server 4 must first simulate the corresponding historical outcome. As with simulating a live outcome, the server 4 simulates the historical outcome by accessing the payout structure 4495 and, based upon the known historical payout, determining the simulated historical outcome. The system 1 proceeds from step 990, as described above, based upon the historical payout and the simulated historical outcome.

It is to be understood that the player tracking card 9 is not essential to the present invention. For example, in an alternative embodiment, the player enters player identifying information via the keypad 570. Moreover, another embodiment requires no player identifying information. Instead of using player identifying information to identify a credit balance, the player merely enters coins into the remote wagering terminal 5. The remote wagering terminal 5, like a conventional slot machine, stores the amount of credit. With each play, the remote wagering terminal 5 deducts the appropriate bet per play.

In step 990, the slot network server 4 proceeds to transmit the live outcome data for those selected slot machines 2 to the remote wagering terminal 5 identified by the remote wagering terminal ID number stored in the record of the session database 446 for that remote player. In the present embodiment, the remote wagering terminal 5 displays the outcome, such as the reel positions (or card values for video poker machines) (as stored in field 4467), as well as the payout information (as stored in field 4468), if any. Moreover, the remote wagering terminal 5 may display the reel positions one at a time, or all at once. Furthermore, the remote wagering terminal 5 simulates play of the selected slot machine 2 based upon the received live outcome by generating a graphical display of spinning reels in the same manner as a conventional slot machine 2. In alternate embodiments employing gaming devices other than slot machines 2, the remote wagering terminal 5 similarly simulates play, such as the graphical dealing of cards or spinning of a roulette wheel.

In step 1000, the slot network server 4 updates the remote player's credit balance field 4466, which is also displayed. After the server 4 updates the player's credit balance field 4466, the server 4, in step 1010, determines whether the player has enough funds remaining to allow continued play. If enough funds remain, the remote play repeats from step 970.

If insufficient funds remain in the credit balance 466, the server 4 directs the remote wagering terminal 5 to display a message indicating a lack of funds. In response, the player may discontinue remote play (step 1020) or the player may deposit additional funds for continued play. To continue remote play, the player deposits funds as described with reference to FIG. 10, or the player deposits funds directly into the remote wagering terminal 5 as described above.

Thus, in some embodiments, upon an execution of a slot machine handle pull by a player playing the slot machine directly (e.g., upon the player placing a wager and pressing a spin button), a player playing the slot machine via a remote wagering terminal 5 may have an opportunity to place a wager in association with the handle pull. For purposes of the following example embodiments, the player playing the slot machine directly is referred to as Player A and the player playing the slot machine via a remote wagering terminal B is referred to as Player B.

In some “live outcome” embodiments, Player A might see a message, such as “Waiting for wager from Player B.” In other words, the resolution of the outcome may be delayed to provide Player B an opportunity to wager on the handle pull prior to the outcome being revealed to Player A. Similarly, Player B might see message prompting him to make a wager on a handle pull initiated by Player A (e.g., “Player A has placed a wager on 9 paylines of Texas Truffles and is ready to spin. Wager how much?”). Thus, in some embodiments Player B might see data regarding Player A's game play (everything but the outcome itself—perhaps amount wagered, type of game, number of paylines, etc.). In one embodiment, the resolution of an outcome for a handle pull upon which it is expected that Player B will wager may be delayed until both wagers are received to reveal outcome to prevent gaming

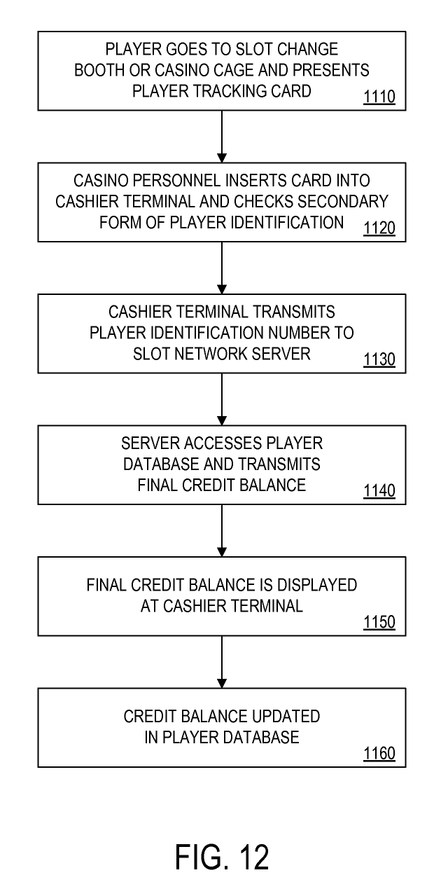

The steps for cashing out when remote play is completed will now be described with reference to FIG. 12. In step 1110, the player takes the player tracking card 9 and goes to the change booth or casino cage and presents the player tracking card 9 to casino personnel. In step 1120, the casino personnel inserts the player card 9 into the card reader 650 of the cashier terminal 6. By having the player's name, which is stored on the card 9, display on the video monitor 680, the personnel is able to check a secondary form of player identification, such as a driver's license. Thus, an imposter would be prevented from receiving disbursements.

Once the secondary form of identification has been checked, the cashier terminal 10 transmits the player ID number to the slot network server 4. This step is illustrated as 1130. As shown in step 1140, the slot network server 4 receives the player ID and player name and proceeds to access the record in the player database 444 corresponding to that player ID number and player name. The slot network server 4 proceeds to transmit the value stored in the credit balance field 4446 to the cashier terminal 6.

Once the cashier terminal 6 receives the credit balance, the cashier terminal 6 displays it to the personnel in step 1150. Thus, having been informed of the credit balance for the particular player, the casino personnel proceed to disburse any amount of cash up to the amount of the credit balance. Whatever amount is disbursed is then entered into the cashier terminal 6 via keypad 670 and transmitted to the slot network server 4. The slot network server 4, in turn, updates the credit balance field 4446 by the amount disbursed.

Alternatively, the player may choose to cash out at the remote wagering terminal 5, thereby receiving coins. In such an embodiment, the remote wagering terminal 5 includes a hopper controller and a payment tray (not shown) for dispensing coins or another means of dispensing or providing the appropriate funds to the player. For example, a cashless payout receipt for the appropriate amount of currency may be printed or an appropriate amount of funds may be transferred to a casino account associated with the player. In the case of a cashout via dispensing of coins, a record of the amount of coins stored in the remote wagering terminal 5 determines whether the remote wagering terminal 5 has enough coins to permit a coin payout.

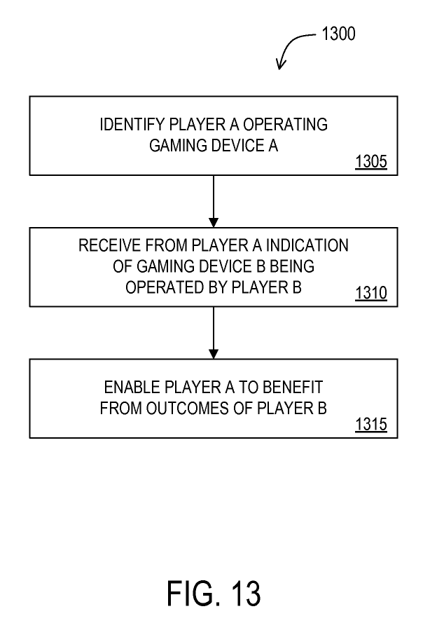

Referring now to FIG. 13, illustrated therein is a flowchart of an example process 1300 consistent with one or more embodiments described herein. In step 1305, a player A who is operating a gaming device A is identified. For example, a player tracking number of player A may be determined. In other embodiments, player A need not be uniquely identified. Rather, step 1305 may comprise merely identifying that a player is currently playing gaming device A without determining any uniquely identifying information about that player.

In step 1310, an indication of a gaming device B being played by player B is received from player A. Thus, player A may provide information identifying a particular gaming device, type of gaming device, game available on a gaming device and/or other information enabling the identification of a particular gaming device or gaming device that fits particular criteria specified by player A. For example, player A may access a menu or other screen and indicate a gaming device by (i) selecting an icon representing gaming device B and/or player B (e.g., a menu is populated with icons representing adjacent, surrounding, nearby or currently eligible gaming devices); (ii) entering a code representing gaming device B and/or player B; and/or (iii) entering criteria descriptive of gaming device B that allows gaming device B to be identified (e.g., game available, denomination available, recent winnings or other performance criteria, manufacturer, bonus features available, etc.). It should be noted that gaming device B is a distinct device than gaming device A for purposes of the present example. Similarly, player B is distinct from player A.

In step 1315, player A is enabled to benefit from the outcomes of player B. In accordance with some embodiments and terminology used herein, it may be said that player A is allowed to “piggyback” onto the game play of player B. As described herein, in some embodiments, player B may be informed (and may, in some embodiments, be required to provide permission) prior to player A being enabled to piggyback off of player B's outcomes. As also described herein, player A and player B may be allowed to place different wagers and select different paylines and/or strategies for each outcome. Thus, the payout received by player A for a given outcome may be distinct from the payout received by player B. In other embodiments, player A benefiting from an outcome obtained by player B may comprise player A receiving a benefit other than a payout based on the outcome.

In some embodiments, if player A (who is electing to piggyback off the results of gaming device B being played by player B) requests to piggyback off the outcomes of an adjacent gaming device B, one or more display screens of both gaming devices may be “merged” to create a “big screen TV” or “wide screen” effect. This may apply to main screens, secondary screens and so on. In some embodiments, both player A and player B would need to agree to such a merging before it is enabled. In some embodiments, one or more of the players may have to proactively select such a feature or respond to a prompt asking whether they'd like to utilize such a feature before it is enabled. The feature would allow two players who have a stake in the same outcome to view outcomes in a more entertaining and easier to see manner.

Of course, the feature of merging together two displays (or virtually doing so, such that part of an outcome is shown on a display of a first gaming device and another part of the outcome is shown on the screen of a second device) may be widely applicable to various types of games, bonusing events and gaming activities, without being limited to piggyback embodiments described herein.

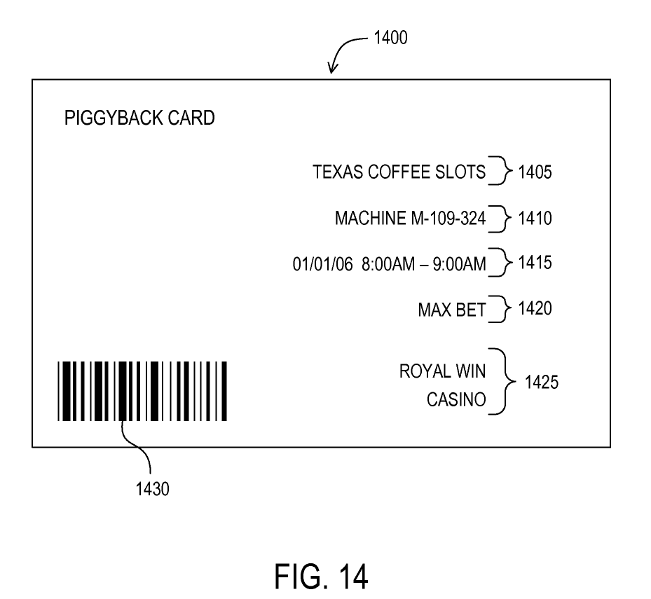

Referring now to FIG. 14, illustrated therein is an example of a tangible medium that may be used to indicate a wager by a player, consistent with at least one embodiment described herein. The tangible medium may comprise, for example, a thin plastic card approximately the size of a credit card or a typical player tracking card. Such a card may have some information printed thereon and/or some information encoded thereon (e.g., in a magnetic strip on the back of the card). In another example, the tangible medium may comprise a paper (e.g., similar to a cashless gaming receipt currently printed out by many gaming devices), cardboard or laminated substrate with some information printed thereon (e.g., including a machine-readable bar code).

Such a medium may comprise one method via which player A playing gaming device A or a remote wagering terminal may purchase and/or activate a piggyback, or remote wagering, session for gaming device B and/or player B. In one embodiment, player A may purchase such a tangible medium (referred to as a “piggyback game card” herein for purposes of brevity) from a casino representative, a kiosk, a gaming device, at a booth or casino cage, etc. Such a piggyback game card may include a bar code, a magnetic stripe or another memory element (e.g., an electrical circuit). Additionally, such a piggyback game card may include text and/or other indicia. The information stored on such a piggyback game card (in one or more formats) may include (i) a player associated with the remote wagering session (e.g., the player remotely wagering on another player, who is purchasing the card, and/or the player on whose outcomes remote wagering is to be conducted); (ii) a gaming device associated with the remote wagering session (e.g., the gaming device at which the remote wagering is occurring and/or the gaming device from which the outcomes being utilized for the remote wagering are originating); (iii) a duration of the remote wagering session (e.g., 1 hour, 100 game plays, the shorter of 1 hour or 100 game plays, etc.); (iv) a specific time period for the remote wagering session (e.g., Jun. 1, 2007, 12-2 pm); (v) a specific time period(s) during which the piggyback game card may be used (e.g., Mon-Thurs., 10 am-4 pm); and/or (v) a paytable and/or probability table to be utilized during the remote wagering session (e.g., lemon-lemon-lemon pays 100 coins; use payout table 0102334-A). With respect to item (vi), it should be noted that the paytable and/or probability table utilized according the piggyback game card may be different than that used by the gaming device originating the outcomes for the remote wagering session and/or the gaming device via which the outcomes for the remote wagering session are being viewed.

A purchaser of such a piggyback game card may view outcomes (i) via “plain view” or by looking over the shoulder of a player directly playing a gaming device; (ii) by inserting the piggyback game card into a gaming device to see if he's won; (iii) via a kiosk, the internet, e-mail, a handheld device, etc. With respect to item (ii), a gaming device (or kiosk or other appropriate device) reads a bar code on the card and notifies the player of any payouts due. For example, if player A purchases a remote wagering session for the outcomes of gaming device B being played by player B, player A may insert a piggyback game card into gaming device A, which would cause gaming device A to open a “window” or display area and output the results from the remote wagering session as output by gaming device B (e.g., which player A plays gaming device A).

A player who purchases a piggyback game card may collect any winnings due to a successful remote wagering session associated with the piggyback game card via a gaming device, kiosk, booth, electronic account, receiving a check in the mail, etc.

Referring specifically to the example piggyback game card illustrated in FIG. 14, included thereon is an indication of (i) the game for the remote wagering session (element 1405); (ii) the gaming device which will originate the outcomes for the remote wagering session (element 1410); (iii) the time of the remote wagering session (element 1415); (iv) the wager to be employed for each game play of the remote wagering session (element 1420); and (v) the gaming establishment at which the remote wagering session is to occur (element 1425). Also included thereon is a machine readable bar code (element 1430) which includes at least some of the above-listed information and, in some embodiments, additional information (e.g., unique identifier of the remote wagering session).

Additional embodiments are encompassed by the present description and would be appreciated upon a reading of the present disclosure. For example, two players may register as a Slot Backbetting Team or Slot Piggyback Team, allowing them to easily bet on each other's next spin(s).

In one example of how a player can select a gaming device to place a remote wager on, a slot player can browse a list of other players on the network, including statistics about their recent play (e.g., “Player X has won 90% of his last 20 spins!”), and place (e.g., anonymous) remote wagers on players accordingly. In yet another example, adjacent machines can be linked together to facilitate a remote wagering session through a simple user interface (e.g., a player can select the machine to his right and place a bet on it). In still another example, a player is shown a map of the slot floor, which he can use to select a particular gaming device and place a remote wager on its next result (e.g., in one embodiment, if a spin does not occur on that gaming device within one minute, the wager is cancelled). In yet another embodiment, an area of a display screen shows current and previous remote wagers, so that players can review how their remote wagers have fared.

Alternate pricing structures are also contemplated for a remote wagering session and/or for the ability to place a remote wager on another player or another gaming device. For example, in one embodiment, placing a remote wager may cost an extra X credits for every Y wagered, or a flat fee of $X. In another example, players may spend $X/day for a Slot Piggyback or Remote Wagering package. Each such package may have one or more restrictions associated therewith. For example, a package may be associated with a limited number of remote wagers, or $Y/day for unlimited number, restricted to particular games/denoms.

It should be noted that the various additional embodiments described above (e.g., Piggyback Team, selection of which gaming device to place remote wagers on, alternate pricing structures) may be found in U.S. Provisional Application Ser. No. 60/943,431, particularly at pages 40-41 under the heading “Slot Backbetting.” The entirety, and particularly pages 40-41, of this application is incorporated by reference herein.

Although the present invention has been described in terms of certain preferred embodiments, other embodiments that are apparent to those of ordinary skill in the art are also intended to be within the scope of the present invention. Accordingly, the scope of the present invention is intended to be limited only by the claim appended hereto.

What is claimed is:

1. A method for facilitating remote play of a gaming device, comprising:
receiving, at a first device and from a first player, an indication of at least one of a second device and a second player associated with the second gaming device, the first device being distinct from the second device and the first player being distinct from the second player, wherein the second device comprises a gaming device operable to facilitate a wagering game; and
enabling the first player at the first device to benefit from an outcome determined via the second device associated with the second player by enabling the first player to place a wager on the outcome.

2. The method of claim 1, wherein the first device comprises at least one of:
a first gaming device operable to facilitate a wagering game;
a handheld device;
a television in a hotel;
a kiosk; and
a remote wagering terminal.

3. The method of claim 1, wherein receiving an indication of at least one of the second device and the second player comprises receiving at least one of:
a characteristic of the second device;
an identifier of the second device;
a characteristic of the second player; and
an identifier of the second player.

4. The method of claim 3, wherein the characteristic of the second player comprises information describing a history of wins of the second player.

5. The method of claim 3, wherein the characteristic of the second device comprises information describing a history of wins obtained at the second device.

6. The method of claim 1, further comprising:
outputting to the first player a menu of eligible devices, wherein receiving an indication of at least one of the second player and the second device comprises receiving from the first player a selection of an eligible device from the menu.

7. The method of claim 1, wherein an outcome determined via the second device comprises an outcome based on a random number generated by at least one of the second device and a server in communication with the second device.

8. The method of claim 1, wherein enabling the first player to benefit from an outcome determined via the second device comprises:
providing a first payout to the first player based on the outcome if the outcome is a winning outcome; and
providing a second payout to the second player based on the outcome if the outcome is a winning outcome.

9. The method of claim 1, wherein the first payout is of a different value than the second payout.

10. The method of claim 1, further comprising:
displaying a representation of the outcome on the first device.

11. The method of claim 1, wherein the first device is adjacent to the second device, wherein the first device comprises a first display and the second device comprises a second display, and further comprising:
merging the first display of the first device and the second display of the second device such that a first portion of the representation of the outcome is displayed via the first display and a second portion of the representation is displayed via the second display.

12. The method of claim 1, further comprising:
receiving a wager from the first player for the outcome prior to at least a display of the outcome via either the first device or the second device.

13. The method of claim 12, wherein the wager from the first player is of a different value than a wager placed on the outcome by the second player.

14. The method of claim 13, wherein the wager from the first player includes an indication of at least one of a payline and a strategy to be employed in determining a payout based on the outcome.

15. The method of claim 14, further wherein the payline indicated by the first player may be different from a payline indicated by the second player for the outcome and the strategy indicated by the first player may be different from a strategy indicated by the second player for the outcome.

16. The method of claim 12, further comprising:
determining that the second player has placed a second wager on the outcome;
prompting the first player to place a first wager on the outcome; and
upon determining that both the first wager and the second wager have been placed, authorizing the display of a representation of the outcome.

17. The method of claim 1, wherein the second player being associated with the second gaming device comprises the second player currently playing the second gaming device, wherein the outcome is a live outcome.

18. The method of claim 1, wherein the second player being associated with the second gaming device comprises the second player having previously played the second gaming device, wherein the outcome is a historical outcome.

19. Apparatus comprising:
a processor;
a memory in communication with the processor, the memory storing a program,
the processor being operable with the memory to:
receive, at a first device and from a first player, an indication of at least one of a second device and a second player associated with the second gaming device, the first device being distinct from the second device and the first player being distinct from the second player, wherein the second device comprises a gaming device operable to facilitate a wagering game; and
enable the first player at the first device to benefit from an outcome determined via the second device associated with the second player by enabling the first player to place a wager on the outcome.

20. A computer readable medium comprising instructions for directing a processor of an apparatus to:
receive, at a first device and from a first player, an indication of at least one of a second device and a second player associated with the second gaming device, the first device being distinct from the second device and the first player being distinct from the second player, wherein the second device comprises a gaming device operable to facilitate a wagering game; and
enable the first player at the first device to benefit from an outcome determined via the second device associated with the second player by enabling the first player to place a wager on the outcome.

21. An article of manufacture comprising:
information defining a remote wagering session, such that the article of manufacture, when inserted into a first gaming device, enables a player associated with the article of manufacture to benefit from outcome determined via a second gaming device that is distinct from the first gaming device.

22. The article of manufacture, wherein the information comprises at least one restriction on the remote wagering session.

23. The article of manufacture of claim 22, wherein at least one of the at least one restrictions comprises a restriction on:
a characteristic of the second gaming device; and
a time period during which the article of manufacture may be used to enable the remote wagering session.

24. The article of manufacture of claim 21, wherein the information comprises at least one of:
a wager to be placed on an outcome of the second gaming device;
an identifier of a player associated with the second gaming device;
a characteristic of a player associated with the second gaming device;
an identifier of the second gaming device;
a characteristic of the second gaming device;
a duration of the remote wagering session; and
a paytable to be utilized to determine a payout amount based on the outcome.
